(19) United States
(12) Patent Application Publication
(10) Pub. No.: US 2003/0081224 A1
(43) Pub. Date: May 1, 2003

(54) Image forming apparatus

(75) Inventor: Takaharu Ouchi, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 09/984,786

(22) Filed: Oct. 31, 2001

(51) Int. Cl. B41B 1/00; G06F 15/00

(52) U.S. Cl. 358/1.2

(57) ABSTRACT

There is disclosed an image forming apparatus comprising in a rotation buffer (32) of A×A bits means for performing rotation by an A×X pixel unit during the rotation of a last X line, and means for clearing the rotation buffer immediately before the rotation of the last X line.

### BACKGROUND OF THE INVENTION

The present invention relates to an image forming apparatus, and more particularly, it relates to an image forming apparatus for controlling image rotation.

The prior art will be described with reference to FIGS. 7 to 17.

First of all, in FIG. 7, the flow of image data in a digital PPC is shown. Image data sent from a scanner, FAX, or PC 14 is first stored in a memory (SDRAM 1010) called a page memory [path (1)]. Next, the image data stored in the page memory is subjected to processing of image shifting, sorting and so on. For example, in the case of the rotating operation, the image data is transferred to a rotation buffer 12 [path (2)]. The image data is then rotated every unit quantity [e.g., 16 bits (one word)×16 bits (one word)], and rearranged in the page memory [path (3)]. Afterward, the thus rearranged image data is transferred to a printing unit 11 [path (4)].

In this case, the SDRAM 10 is used for the page memory, thereby enabling high-speed data transfer to be carried out based on burst transfer. In addition, in order to permit the burst transfer, the image data is stored in accordance with a certain rule. This operation will now be described. Regarding the SDRAM 10 used for the description, it is assumed that Co1 addresses are from 00H to FFH, and data of one word (16 bits) can be stored in one memory cell.

Next, consideration is given to the case of storing the image of horizontal 1920 dots×vertical 1605 lines, as shown in FIG. 8. Furthermore, FIG. 9 shows the state of the image of FIG. 8 actually stored in the memory.

As shown in FIG. 9, the data of one line is stored by being folded every 16 words. For example, in the 1st line, the data is stored in the portion of 1 to 120 words of FIG. 9. In the 2nd line, the data is stored similarly in the side (Co1 direction) of the first line (121 to 240 words). In this example, the data of 16 lines enter in the Co1 direction.

In the 17th line, the data is stored from an address (1921 words in FIG. 9) next to the end address of the 1st line while being folded similarly to the case of the 1st line. Thereafter, the data up to 1605 lines (192600 words) is similarly stored. Regarding the rotation of the image, the image data of 16 bits (one word) is stored in one memory cell as described above, and hence, the image cannot be rotated simply by data rearrangement.

Therefore, as shown in FIG. 10, the data of 16 bits (one word)×16 bits (one word) is taken out, and the rotating operation is then carried out by reading the data in the rotational direction. The rotation of the unit of 16 bits (one word)×16 bits (one word) is performed for all the images. The rotation of the image is performed by sequentially reading the data from a left upper position of the image.

For example, in the image of FIG. 8, 1, 121, 241, . . . , 1801 words are read in a rotational direction. In this case, the 1, 121, . . . , 1801 words are present on the same Row address, and therefore, the burst transfer can be performed. In the case of a clockwise rotation of 90°, as shown in FIG. 10, 1A, 121A, 241A, . . . 1801A words are read. The read data are rearranged as shown in FIG. 11 for the actual image, and as shown in FIG. 12 for SDRAM. Here, since the 1A, 121A, . . . , 1801A words are also present on the same Row address, the burst transfer can be performed. In addition, for the next data of 16 bits (one word)×16 bits (one word), 2, . . . , 1802 words are read to similarly perform the rotation as shown in FIG. 8, and 2A, . . . , 1802A words are rearranged as shown in FIGS. 11 and 12. Thereafter, the rotation is performed up to 1600 lines in the similar manner. Then, the remaining number of lines is 5. However, since the rotation is carried out every unit of 16 bits (one word)×16 bits (one word) as described above, the rotating operation is carried out up to the lines including extra 11 lines, i.e., from 1601 to 1616 lines. The portion of these 1601 to 1616 lines is shown in FIG. 13.

As shown in FIG. 13, in the block of 16 bits (one word)×16 bits (one word) on the leftmost side of the lines 1601 to 1616, 192001, 192121, . . . , 192481 words are in a valid image region, but 192801, . . . , 193801 words are added to the above words to carry out the rotation for 16 words. This is rotated clockwise 90° and 192001A, . . . , 193920A words are read and then rearranged as shown in FIGS. 11 and 12. Thereafter, similar rotation is performed up to 193920 words.

In this case, an extra region having a width of 11 dots is added to the left side of the image after the rotation. To delete this extra region, data shifting of 11 bits is necessary. However, since the data of one word (16 bits) is stored in one memory cell as described above, the deletion of the extra region is impossible only by data rearrangement, and all the data of one image must be converted. This operation places a great burden on the system, and hence, there may be used a method in which a specification is ignored and the above data shifting is not carried out. If the specification is ignored, the extra region is included in the valid image region. If black data is mixed in the extra region, it becomes conspicuous. Thus, control is performed to forcibly bury white data in this region (hereinafter referred to as white burying). The region subjected to the white burying corresponds to an invalid image region shown in each of FIGS. 9 and 13. Furthermore, in the cases of clockwise rotations of 180° and 270°, rotating operations are carried out similarly to the case of a clockwise rotation of 90°. FIG. 14 shows an image in the case of a clockwise rotation of 180°; FIG. 15 an image data arrangement in the memory in the case of a clockwise rotation of 180°; FIG. 16 an image in the case of a clockwise rotation of 270°; and FIG. 17 an image data arrangement in the memory in the case of a clockwise rotation of 270°.

However, the conventional method necessitated the execution of control for white burying in the extra region (the lines of 1606 to 1616 in the above-described example) when the number of image lines was not a multiple of 16. For the execution of the control, a white burying circuit must be provided, causing an increase in the size of a circuit. In addition, the white burying control is necessary for the rotating operation. However, since the white burying control must be performed when all the image data in the memory are rewritten (e.g., data writing from a scanner, data rewriting by an image shifting operation, and so on), the number of items to be verified concerning the white burying control is increased at the time of development, increasing the possibility of inconveniences caused by the control. Other problems inherent in the conventional method includes the necessity of securing an invalid image region portion in the memory, the necessity of time for accessing this region, and so on.

### BRIEF SUMMARY OF THE INVENTION

It is an object of the present invention to provide an image forming apparatus capable of eliminating the necessity of performing white burying control.

A first aspect of the invention is directed to an image forming apparatus comprising, in a rotation buffer of A×A bits, means for rotating a last X line every A×X pixel unit, and means for clearing the rotation buffer immediately before the rotation of the last X line.

A second aspect of the invention is directed to an image forming apparatus comprising, in a rotation buffer of A×A bits, means for rotating a last X line every A×X pixel unit by counting the number of data transferred to the rotation buffer, and means for clearing the rotation buffer immediately before the rotation of the last X line, A being an optional integer of 2 or more, and X being an optional integer of A or lower.

A third aspect of the invention is directed to an image forming apparatus comprising, in a rotation buffer of A×A bits composed of an SRAM, means for rotating a last X line every A×X pixel unit by counting the number of data transferred to the rotation buffer, and means for clearing the rotation buffer immediately before the rotation of the last X line, A being an optional integer of 2 or more, and X being an optional integer of A or lower.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing a configuration of an electronic copying machine as an image forming apparatus according to an embodiment of the invention.

FIG. 2 is a view showing a state of an image of horizontal 1920 dots×vertical 1605 line stored in a memory according to the embodiment of the invention.

FIG. 3 is a view showing each-direction rotation of an image of 16×16 dots performed by a rotation buffer according to the embodiment of the invention.

FIG. 4 is a block diagram showing a system for achieving an actual operation according to the embodiment of the invention.

FIG. 5 is a flowchart showing a flow of the system for achieving the actual operation according to the embodiment of the invention.

FIG. 6 is a flowchart showing a flow of the system for achieving the actual operation according to the embodiment of the invention.

FIG. 7 is a view showing a flow of image data in a digital PPC of a conventional art.

FIG. 8 is view showing a case of storing an image of horizontal 1920 dots×vertical 1605 line of the conventional art.

FIG. 9 is a view showing a case of rotating the image of horizontal 1920 dots×vertical 1605 line of the conventional art.

FIG. 10 is a view illustrating a rotating operation of the conventional art.

FIG. 11 is a view showing a rearrangement according to the conventional art.

FIG. 12 is a view showing a rearrangement according to the conventional art.

FIG. 13 is a view illustrating valid and invalid image regions of the conventional art.

FIG. 14 is a view showing an image clockwise rotated by 180° according to the conventional art.

FIG. 15 is a view showing an image data arrangement in the case of the clockwise image rotation by 180° according to the conventional art.

FIG. 16 is a view showing an image clockwise rotated by 270° according to the conventional art.

FIG. 17 is a view showing an image data arrangement in the case of the clockwise image rotation by 270° according to the conventional art.

### DETAILED DESCRIPTION OF THE INVENTION

Next, preferred embodiments of the present invention will be described with reference to the accompanying drawings.

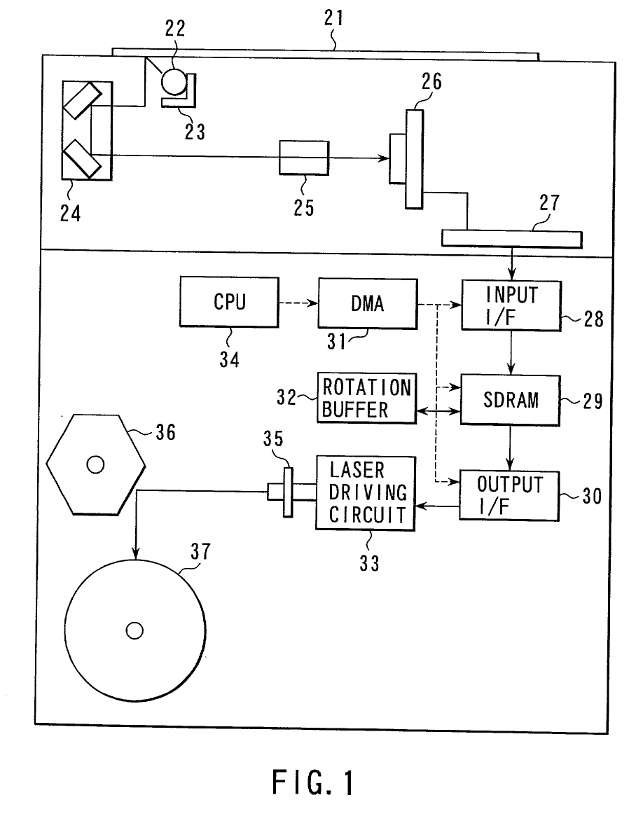

FIG. 1 shows the configuration of an electronic copying machine as an image forming apparatus according to the embodiment of the invention. A scanner shown in FIG. 1 is a well-known one for reading a document 21. A reference numeral 22 denotes an exposure lamp adapted to radiate a light to expose the surface of the document. A reference numeral 23 denotes a first carriage composed of the exposure lamp 22, a reflector, a first mirror, and so on, and adapted to scan a document surface in a sub-scanning direction; and 24 a second carriage composed of second and third mirrors, and adapted to send a reflected light from the document surface to a CCD driving circuit 26. The CCD driving circuit 26 converts the reflected light of the document surface into an electric signal. A reference numeral 27 denotes an image processing circuit adapted to perform a series of image processing including shading correction, gamma correction, and so on, for an image signal converted into an electric signal by the CCD driving circuit 26.

The image data that has been subjected to the foregoing image processing is converted by an input I/F circuit 28 into a form to be processed by a main body, and then stored in a SDRAM 29. The stored image data is transferred to an output I/F circuit 30. To perform image rotation in this case, the image state stored in the SDRAM 29 is rotated by each unit quantity at a rotation buffer 32 composed of an SRAM or the like, the data is rearranged in the SDRAM 29, and transferred to the output I/F circuit 30.

The data transfer among the input-output I/F circuits 28 and 30, the SDRAM 29 an the rotation buffer 32 is controlled by a DMA controller 31, which is in turn controlled by a CPU 34. A laser control circuit 33 performs optical pulse modulation based on a data signal sent from the output I/F circuit 30 while correcting the temperature of a laser diode 35. The laser diode 35 converts the data signal into a light by a laser driving circuit. A polygon motor 36 reflects a laser beam while rotating, and scans in a main scanning direction on a photosensitive drum 37. The photosensitive drum 37 has an outer side formed of a photoconductive layer using an organic photoconductor, and an inner side formed of an aluminum substrate as a conductor. This photosensitive drum 37 is a well-known one having a material resistance value changed by an external light, and adapted to copy, on a copying paper sheet, a document set in a fixed position on a document platen installed on a scanner by each process (not shown) such as charging, exposing, developing, transferring, fixing, cleaning or discharging.

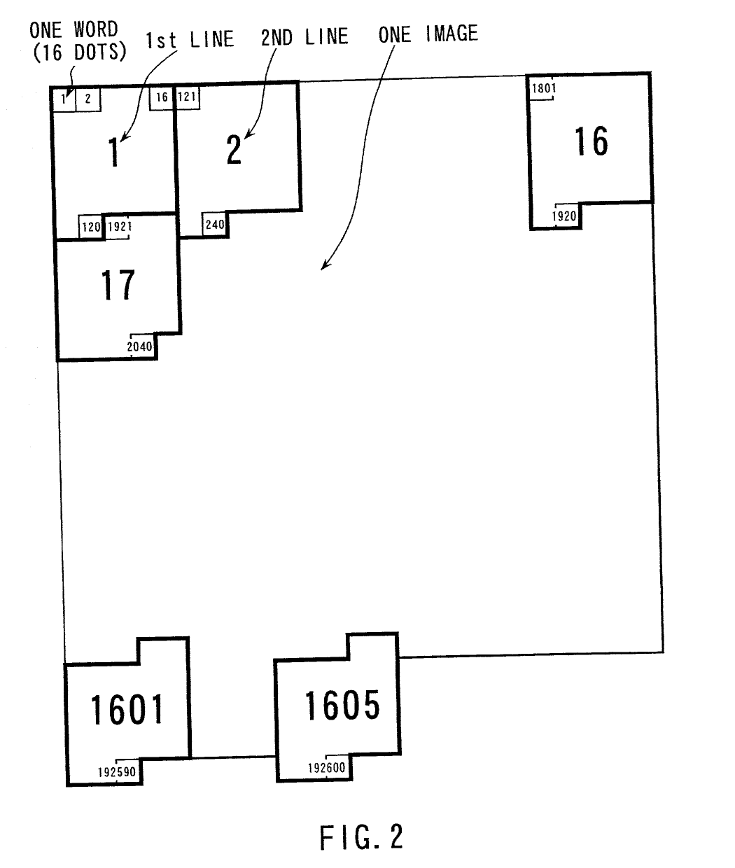

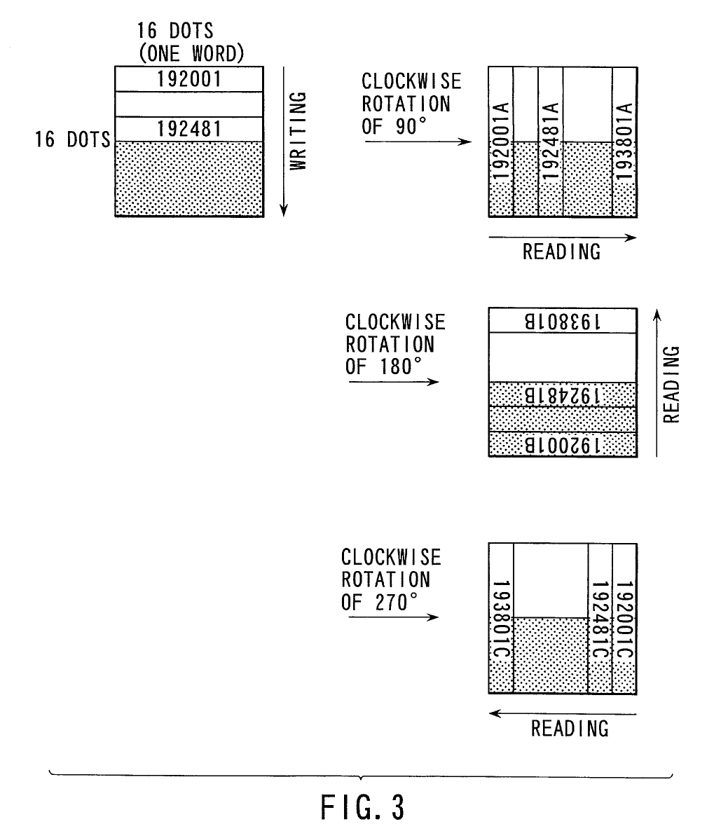

Now, consideration is given to the case of rotating the image of horizontal 1920 dots×vertical 1605 line as shown in FIG. 2 in the digital copying machine. The image data are first transferred from the input I/F unit to the SDRAM. In this case, the data are stored in the SDRAM in a manner as shown in FIG. 3. For the SDRAM, it is assumed that Co1 addresses are 00H to FFH, and the data of one word (16 bits) can be stored in one memory cell. In addition, the data of one image line is stored by being folded for every 16 words in the SDRAM.

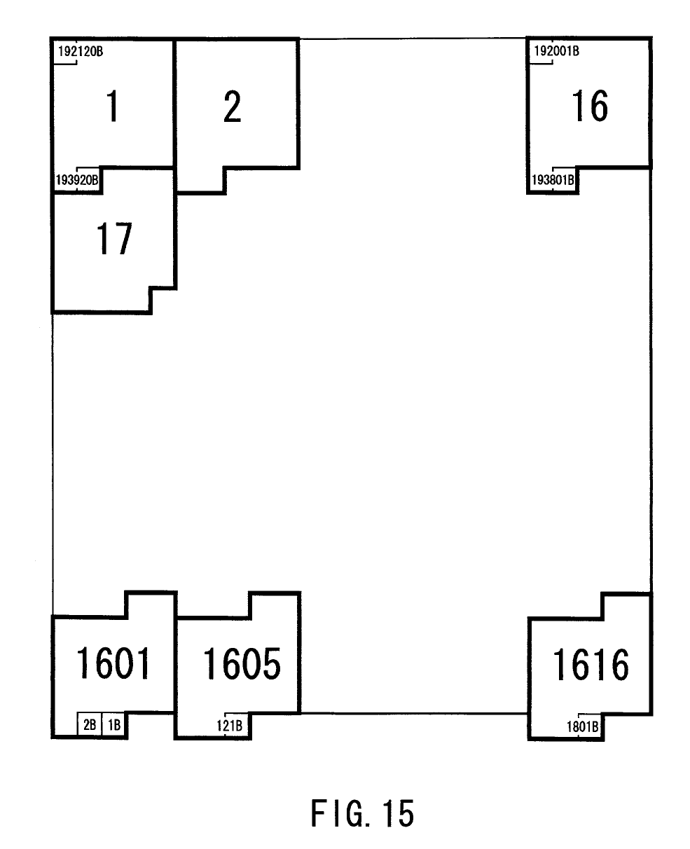

For example, FIG. 3 shows the processing of storing data in each line. As shown in FIG. 3, the data is stored in the portions of 1 to 120 words of the 1st line. In the 2nd line, the data is similarly stored in the side (Co1 direction) of the 1st line. In this example, the data of 16 lines enters in the Co1 direction. In the 17th line, the data is stored from an address (1921 word in FIG. 3) next to the end address of the 1st line, by being folded similarly to the case of the 1st line. Thereafter, the data up to 1605 lines (192600 words) is similarly stored. In other words, the process is almost similar to the conventional method (FIG. 15), but it is different in that there are no white burying regions.

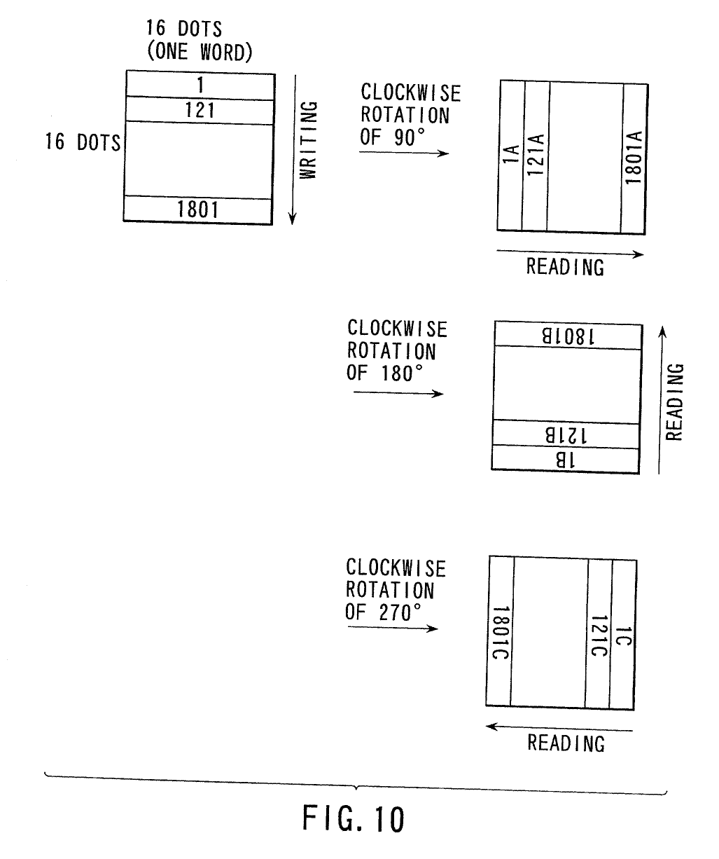

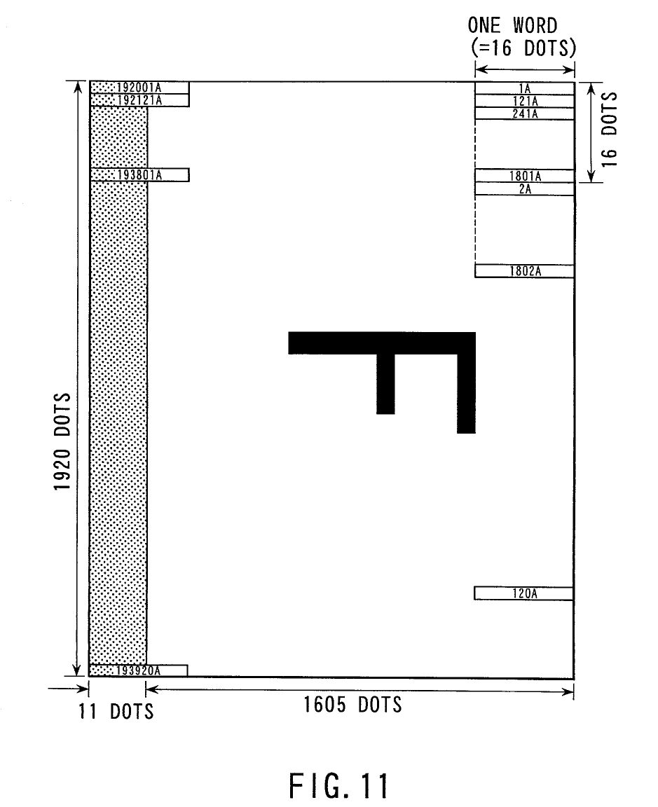

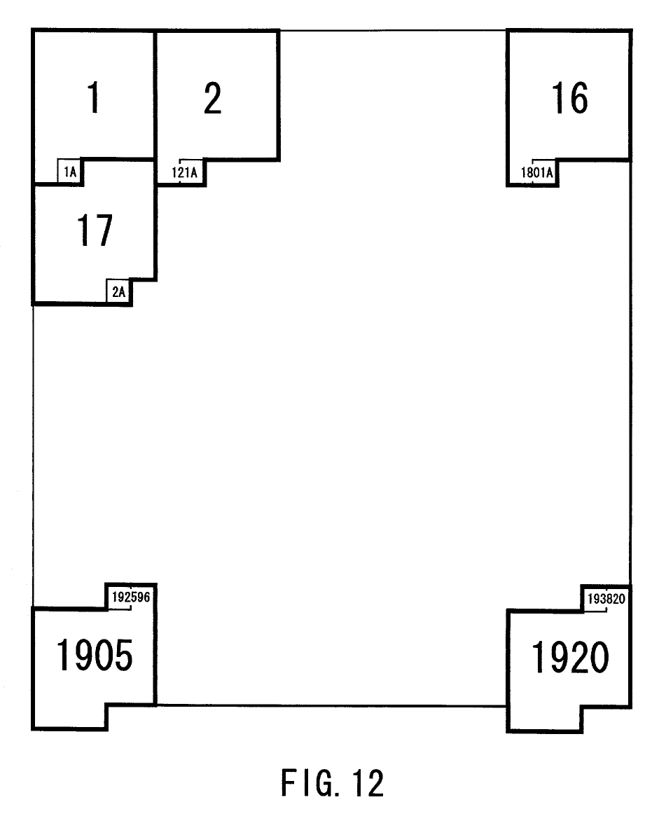

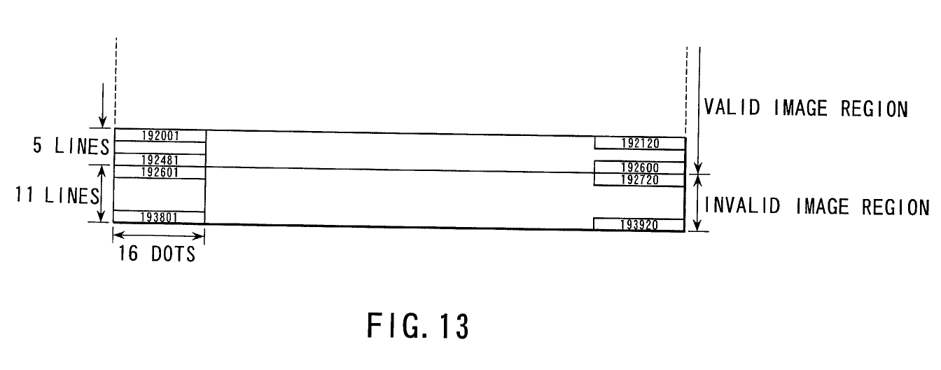

Next, description will be made of the method of rotating the image stored in the SDRAM. Concerning image rotation, since the image data of 16 bits (one word) is stored in one memory cell as described above, the image cannot be rotated by simple data rearrangement. Thus, as shown in FIG. 10, the data of 16 bits (one word)×16 bits (one word) is taken out, and a rotating operation is carried out by reading the data according to a rotational direction. For example, in the case of the image shown in FIG. 8, 1, 121, 241, . . . , 1801 words are read according to the rotational direction. For clockwise rotation, 1A, 121A, 241A, . . . , 1801A words are read as shown in FIG. 10. For example, in the case of a clockwise rotation of 90°, the read data are rearranged as shown in FIG. 11 for an actual image and as shown in FIG. 12 for the SDRAM. For the next data of 16 bits (one word)×16 bits (one word), as shown in FIG. 3, 2, . . . 1802 words are read to perform similar rotation, and 2A, . . . , 1802A words are rearranged like those shown in FIGS. 11 and 12. Thereafter, rotation is similarly carried out up to 1600 lines. Then, the remaining number of lines is 5. In the convention system, rotation was carried out for totally 16 lines combining the remaining 5 lines and the extra 11 lines. In the new system, however, rotation is performed only for the remaining 5 lines. For this purpose, rotation is enabled for 16 bits (one word)×X bits (X: optional value of 1 to 16) in the rotation buffer. If 16 bits (one word)×X bits is rotated by 90° or 270°, then X bits×16 bits (one word) is set. Since one memory cell of the SDRAM stores 16 bits (one word) as described above, if the data of X bits is directly stored, an extra is generated. Accordingly, when data transfer is carried out from the rotation buffer to the SDRAM, X bits are converted into data of 16 bits (one word), and then transfer is executed.

Now, the method will be described in detail. In the case of rotating an image in the leftmost side of 1601 to 1605 lines, as shown in FIG. 3, the data of 5 words including 192001, 192121, . . . , 192481 are transferred according to a rotational direction. In this case, as shown in FIG. 3, the number of data to be read is 16 words irrespective of the number of data written in the rotation buffer. In other words, a space portion formed in the rotation buffer is also read out. After the rotation, since this space portion is also included in the valid image region, this portion must be white data (white burying region). Thus, during the rotation of the last Y line (Y: optional value of 1 to 15) of the image, a state where a space portion formed in the rotation buffer is white data is set by clearing the rotation buffer before its use. The data read from the rotation buffer are rearranged in the SDRAM in such a manner as shown in FIG. 12. In other words, the image data arrangement in the SDRAM after the rotation is similar to that of the conventional method.

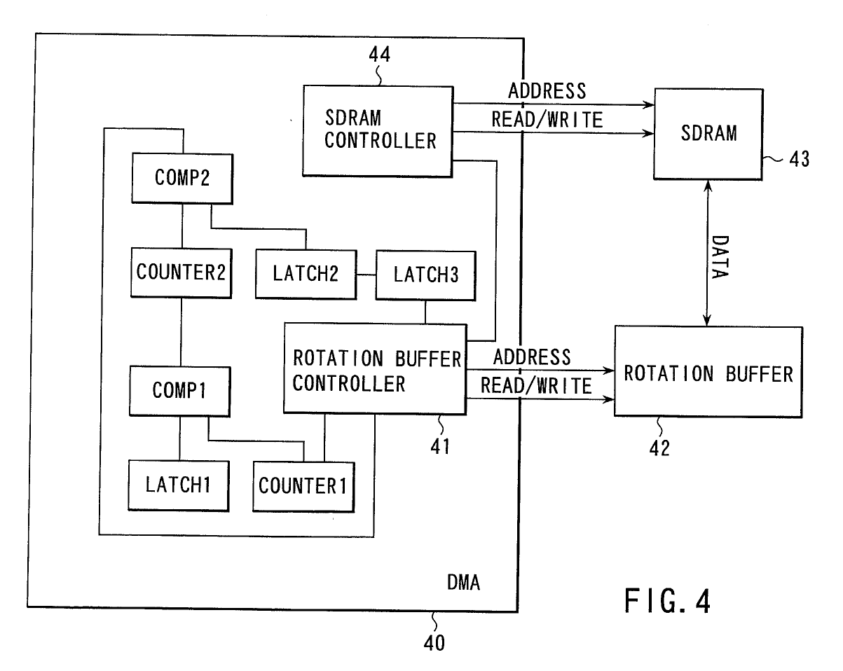

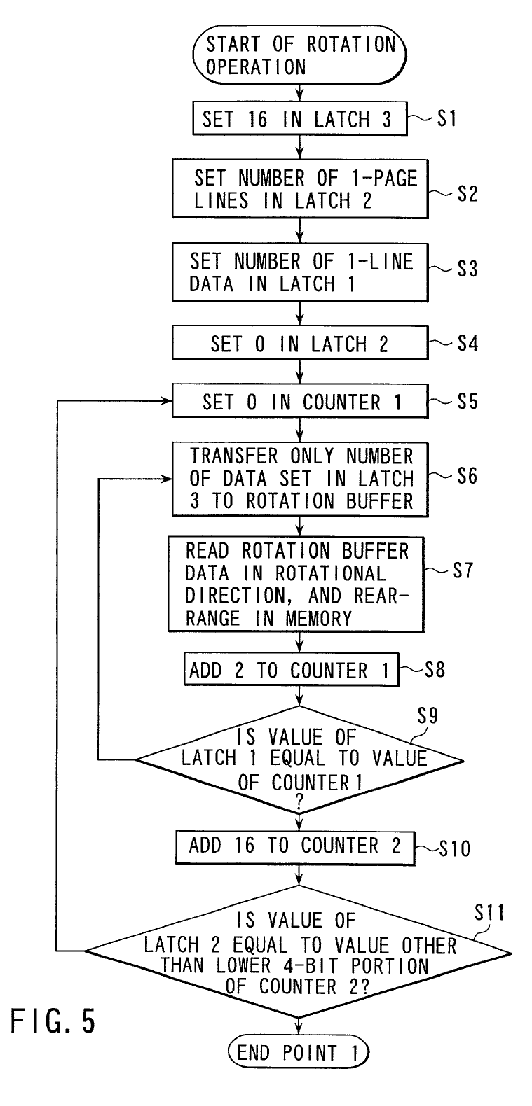

An image shown in the above case is shown in FIG. 11. FIGS. 4 and 5 are respectively a block diagram and a flowchart showing a system for actually achieving the foregoing operation. The operation is now described in detail. The number of 1-line data (words), the number of 1-page lines, and 16 are respectively set in latch 1, latch 2a and latch 3. Here, In the latch 3, the number of words rotated once by the rotation buffer is set, and an initial state is 16. In addition, 0 is set in each of counter 1 and counter 2. From this condition, a rotating operation is carried out for each number (16 words) set in the latch 3.

In this case, the number of times of rotation by the rotation buffer is counted by the counter 1. The number of times of coincidence between the values of the counter 1 and the latch 3 is counted by the counter 2. Coincidence between the values of the counter 1 and the latch 1 means that the rotation has been completed up to the rightmost end of the image before the rotation. The number of times of coincidence between the values of the counter 1 and the latch 1 is equal to a value obtained by dividing the number of rotation-completed lines with 16. Coincidence between one obtained by shifting the value of the counter 2 by upper 4 bits (16 times larger) and a portion other than lower 4 bits of the latch 2 means that the number of remaining lines is less than 16. In addition, determination is made as to whether the lower 4-bit portion of the latch 2 is 0 or not. If 0, it means the completion of the rotating operation, and hence the operation is finished. If the lower 4-bit portion of the latch 2 is other then 0, the process proceeds to the rotating operation of the last Y line.

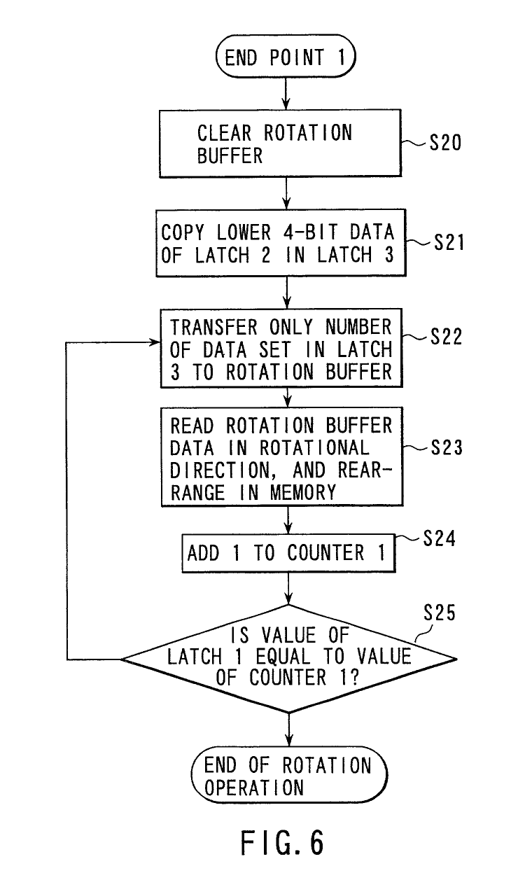

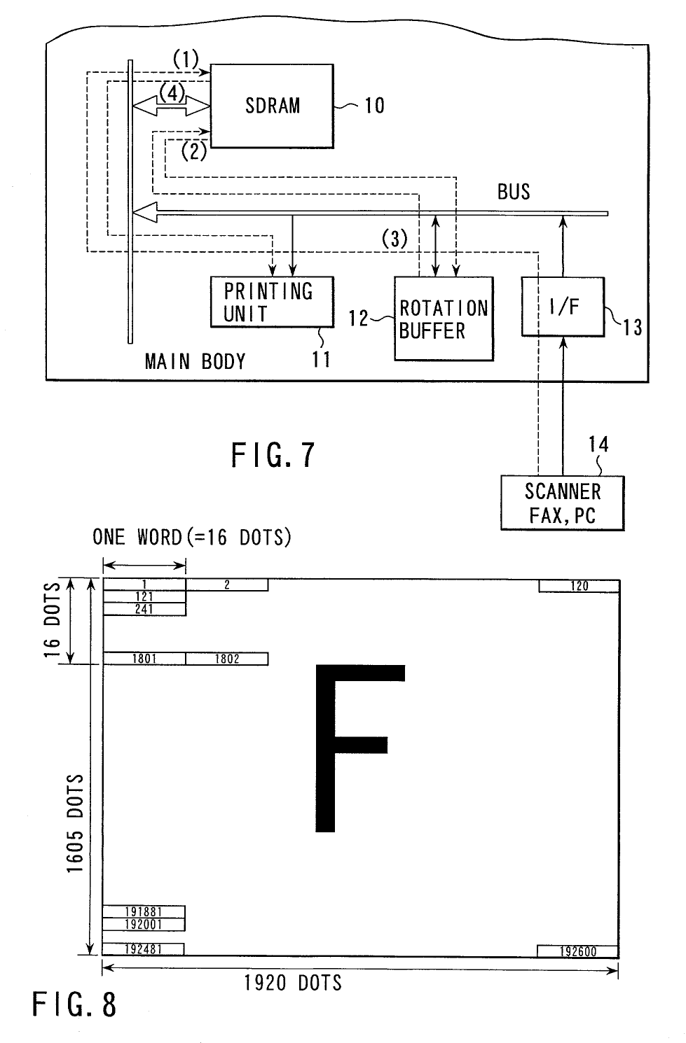

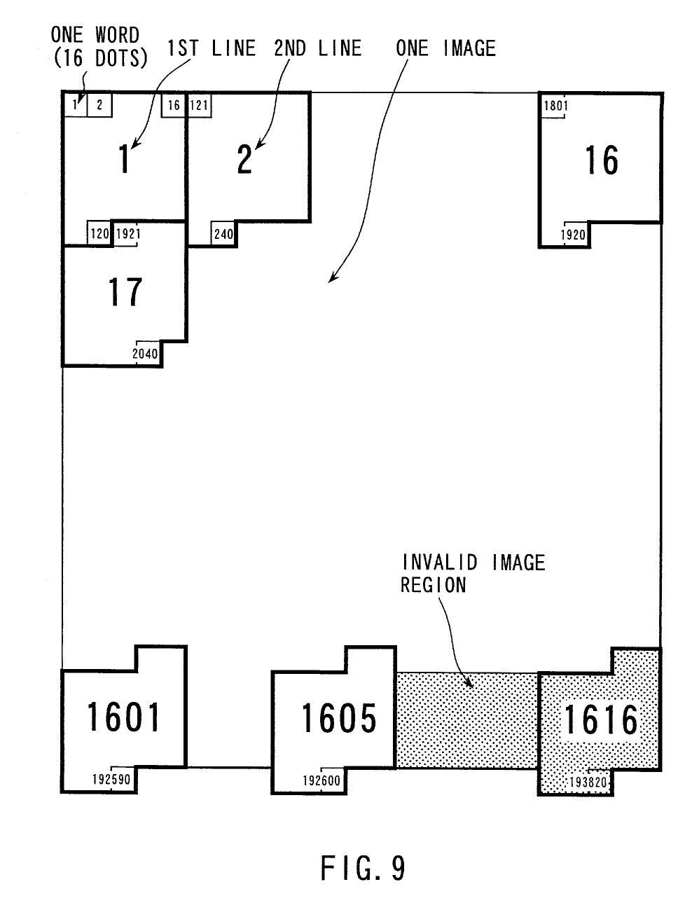

Then, as shown in FIG. 6, first, the rotation buffer is cleared. Subsequently, the lower 4-bit portion of the latch 2 is set to latch 3. Then, the rotating operation is carried out by transferring only the number of data set in the latch 3 to the rotation buffer. Thereafter, a similar rotating operation is performed and, when coincidence is reached between the values of the latch 1 and the counter 1 (rotating operation has been completed up to the right end of the image), it means the rotation of one page has been completed.

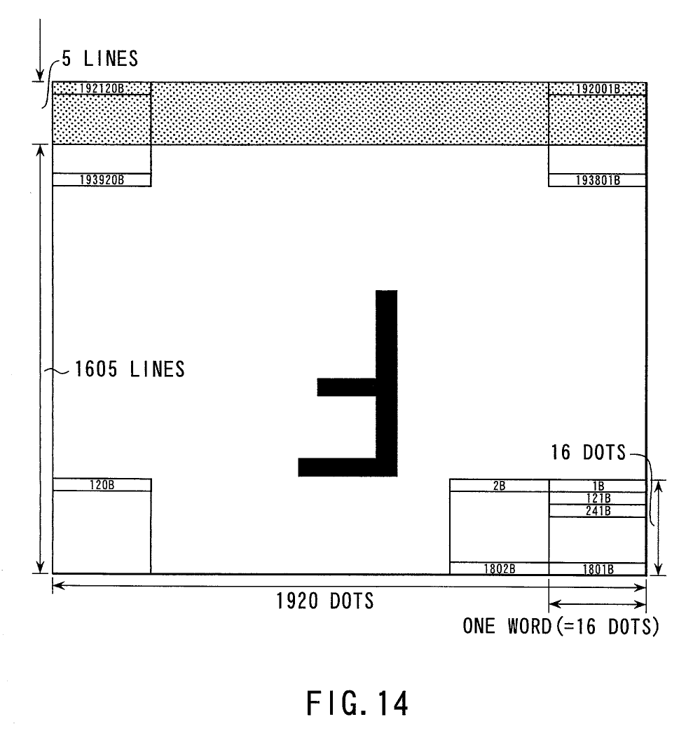

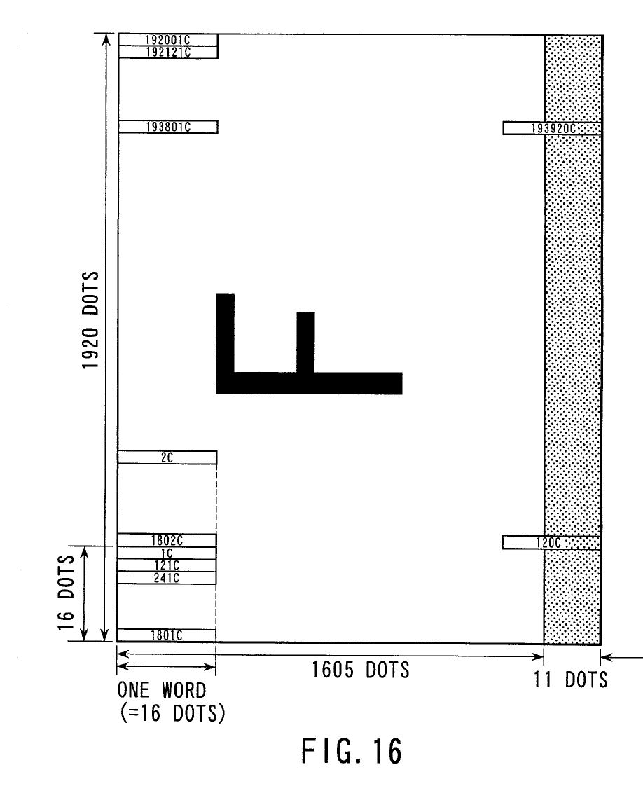

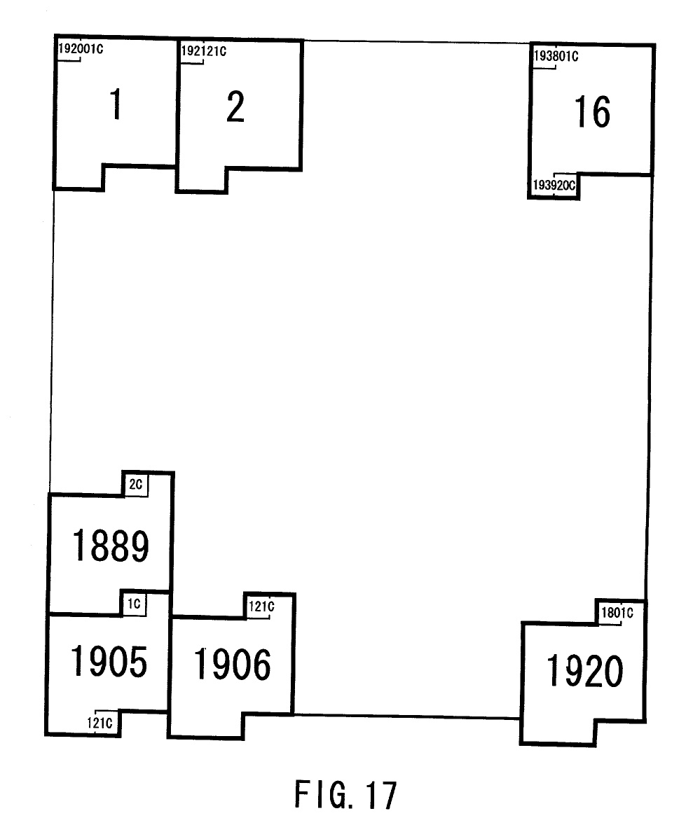

A clockwise rotation of 90° has been described. It should be understood that the clockwise rotations of 180° and 270° are similar to the foregoing. As shown in FIG. 3, when the data are read according to the rotating direction, and clockwise rotated by 180°, the data are rearranged as shown in FIG. 15; and rearranged as shown in FIG. 17 in the case of a clockwise rotation of 270°. Images obtained in these cases are respectively shown in FIGS. 14 and 16.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming apparatus comprising, in a rotation buffer of A×A bits;
means for rotating a last X line every A×X pixel unit, and
means for clearing the rotation buffer immediately before the rotation of the last X line,
A being an optional integer of 2 or more, and X being an optional integer of A or lower.

2. An image forming apparatus comprising, in a rotation buffer of A×A bits;
means for rotating a last X line every A×X pixel unit by counting the number of data transferred to the rotation buffer during the rotation of a last X line, and
means for cleaning the rotation buffer immediately before the rotation of the last X line,
A being an optional integer of 2 or more, and X being an optional integer of A or lower.

3. An image forming apparatus comprising, in a rotation buffer of A×A bits composed of an SRAM:
means for rotating a last X line every A×X pixel unit by counting the number of data transferred to the rotation buffer, and
means for clearing the rotation buffer immediately before the rotation of the rotation of the last X line,
A being an optional integer of 2 or more, and X being an optional integer of A or lower.
